(19) United States
(12) Patent Application Publication
(10) Pub. No.: US 2017/0008569 A1
(43) Pub. Date: Jan. 12, 2017

(54) HOLDER FOR A SUSPENSION STRUT

(71) Applicant: ZF FRIEDRICHSHAFEN AG, Friedrichshafen (DE)

(72) Inventors: Peter HOFMANN, Starnberg (DE); Matthias MOELLER, Buende (DE)

(21) Appl. No.: 15/116,259

(22) PCT Filed: Jan. 20, 2015
(86) PCT No.: PCT/EP2015/050996

§ 371 Date: Aug. 3, 2016

(30) Foreign Application Priority Data
Feb. 21, 2014 (DE) 10 2014 203 125.7

(51) Int. Cl. B62D 25/08; B62D 29/04

(52) U.S. Cl. CPC B62D 25/088; B62D 29/043

(57) ABSTRACT

A holder (1) for a shock-absorber element, in particular for a suspension strut of a motor vehicle. The holder has a supporting mounting (7) for the shock-absorber element. The holder (1) and the supporting mounting (7) are made integrally with one another as an organic sheet component (1a).

This application is a National Stage completion of PCT/EP2015/050996 filed Jan. 20, 2015, which claims priority from German patent application serial no. 10 2014 203 125.7 filed Feb. 21, 2014.

### FIELD OF THE INVENTION

The invention concerns a holder for a shock-absorber element, in particular for a suspension strut of a motor vehicle, with a supporting mounting for the shock-absorber element.

BACKGROUND OF THE INVENTION

A suspension strut holder is known, for example from DE 10 2008 050 297 A1. Suspension strut holders in vehicles serve to hold a suspension strut of a chassis and to take up and pass on the forces that act on the vehicle body or the chassis. Thus, they constitute the connection between the suspension strut and the vehicle body.

Suspension strut holders comprise a suspension strut supporting mounting for mounting the upper end of a suspension arm in a motor vehicle. The suspension strut supporting mounting is connected to the upper end of the suspension strut and is in the form of an elastomer mounting that absorbs oscillations of the suspension strut, The elastomer mounting is arranged in a housing, which is attached to the wall of the suspension strut holder. In addition, the suspension strut holder comprises a compression buffer in a stop pot, which serves as the end stop of the spring deflection. The wall of the suspension strut holder, the housing of the suspension strut supporting mounting and the stop pot are made of aluminum. Accordingly, conventional suspension strut holders are relatively weighty and are complicated to produce.

There is therefore a need to provide a holder for a shock-absorber element, in particular a suspension strut of a motor vehicle, which is lighter, and/or which can be produced more simply than conventional suspension strut holders.

### SUMMARY OF THE INVENTION

This objective is achieved by virtue of the invention as described below.

According to the invention a holder for a shock-absorber element, in particular for a suspension strut of a motor vehicle is provided, which has a supporting mounting for the shock-absorber element and is characterized in that the holder and the supporting mounting are made integrally in one piece as an organic sheet component.

The present invention is based on the recognition that by using organic sheets as the material, functional components of the holder can be combined and integrated. In this, the elastically resilient properties of the organic sheet are used to replace the elastomer mounting, including the housing for the elastomer mounting. By using fewer components the weight of the holder is reduced,

A further advantage of the present invention is that fewer joints are needed in the area of the supporting mounting, and this results in better encapsulation against dirt and environmental factors.

Furthermore the production of the holder is simplified, For example, the rolling processes required for conventional suspension strut holders (interlocked attachment of a cover) in order to seal the mounting can be omitted.

In the context of the present invention organic sheet is understood to mean a fiber-plastic composite material (FPC) in the form of a thermoplastic reinforced with an endless fiber. Suitable for this are reinforcing fibers such as glass fibers, carbon fibers or aramide or Kevlar fibers, especially in the form of endless fibers, which take the load. To ensure the fiber orientation and the shape stability, the above-mentioned reinforcing fibers are imbedded in a thermoplastic matrix material (such as polyamide, PA). The fibers imbedded in the matrix material can be orientated in one direction or they can be arranged as a fabric or layer at any desired angle to one another.

The present invention is particularly suitable for holding suspension struts, as used for example in McPherson axles. Such suspension struts consist essentially of a spring, a shock-absorber and a knuckle. Such suspension struts constitute a particular form of the individual wheel suspension on the front axle of a vehicle. The suspension strut forms the connection between the wheel carrier and the vehicle body. The suspension strut serves for the sprung suspension of the vehicle, limiting the compression and extension movements (by virtue of tension and compression stops), damping oscillations, holding the suspension strut mounting for the connection to the body, and transmitting the steering movements.

However, the present invention is also suitable for holding a shock-absorber of a dual transverse arm axle. In dual transverse arm axles the wheel carrier is guided by two wishbone transverse arms and a track rod. The vertical support is provided by the suspension strut attached on the lower transverse arm.

In one design, the area of the holder that forms the supporting mounting, or organic sheet component, is made elastically resilient, especially in the direction of a spring deflection of a shock-absorber element held in the holder. The elastically resilient properties of the supporting mounting can be adapted additionally, in that the area of the holder forming the supporting mounting has a surface that is uneven. For example, the area of the holder forming the supporting mounting can be round or annular and can have a corrugated surface wherein the corrugations run concentrically around the mid-point of the area of the holder forming the supporting mounting. Such a surface improves the resilience properties of the supporting mounting. In particular, a surface that is uneven assists springiness in the axial direction and enables resilience properties to be obtained which are comparable with those of a conventional elastomer mounting.

In another design the uneven surface is formed by one or more corrugations which run concentrically around the mid-point of the area of the holder that forms the supporting mounting. By virtue of the corrugations, cardanic movements can also be cushioned.

In a design version, the area of the holder forming the supporting mounting, or the organic sheet component, is less rigid than other, or all the other areas of the organic sheet component. In particular, in the area of the supporting mounting the organic sheet component is elastically resilient, whereas in contrast, in the areas where it is connected to the vehicle body it is made as rigid as possible. For example, the organic sheet component contains two different reinforcing fibers. In particular, the area of the organic sheet component forming the supporting mounting contains reinforcing fibers which are less rigid than the reinforcing fibers present in other, or all the other areas of the organic sheet component. Thus the supporting mounting can be made sufficiently elastic to provide the desired spring properties. On the other hand, the other areas of the organic sheet component can have the rigidity required for connection to the body. In a design version the more rigid reinforcing fibers consist of carbon and/or graphite fibers.

In a version of the invention, a plastic inner element is injection-molded onto an inner side of the holder, in particular a plastic inner element which coats the inside of the holder. The plastic inner element can comprise connecting and/or fastening elements, for example for the connection or guiding of cables or leads. This can be done in a single production step, which additionally simplifies the production of the holder.

In a design version, the plastic inner element has one or more reinforcing ribs. For example, the reinforcing ribs can be arranged in the area around the supporting mounting. This additionally increases the rigidity of the holder, particularly in the area adjacent to the elastically resilient supporting mounting.

### BRIEF DESCRIPTION OF THE DRAWINGS

Below, an example embodiment of the invention is described in greater detail with reference to the drawings, which illustrate in schematic form:

FIG. 1: A perspective view of the outside of a suspension strut holder according to an embodiment of the invention;

FIG, 2: A perspective view of the inside of the suspension strut holder shown in FIG. 1;

FIG. 3: A cross-section through the suspension strut holder shown in FIGS. 1 and 2.

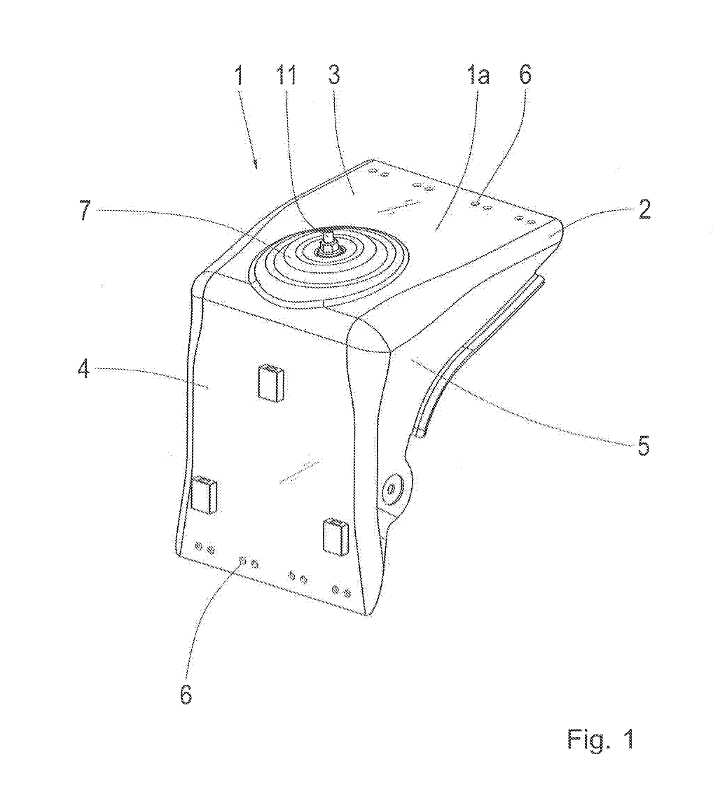

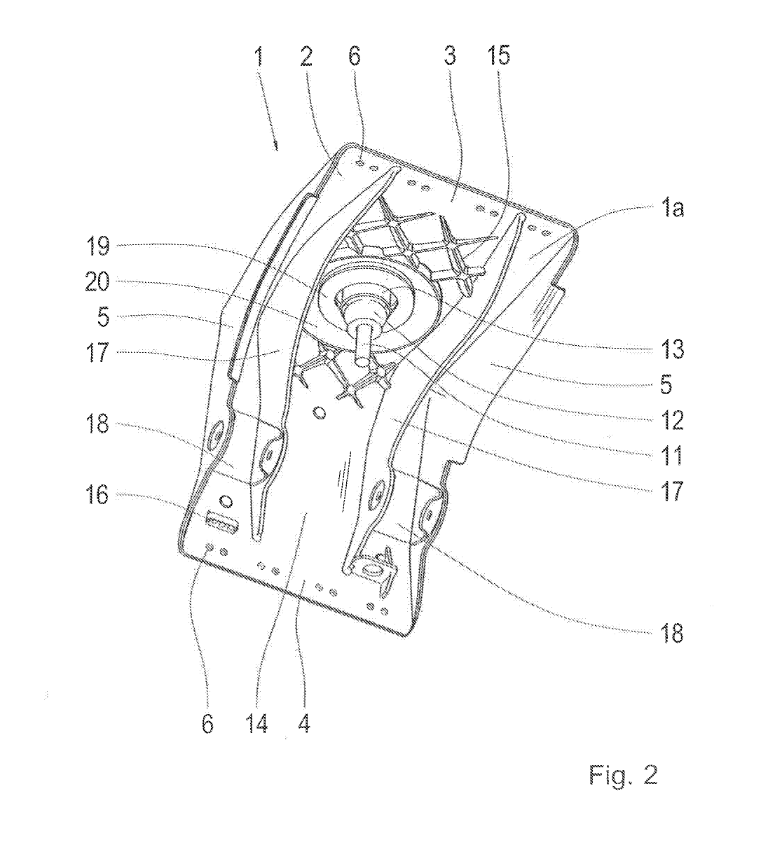

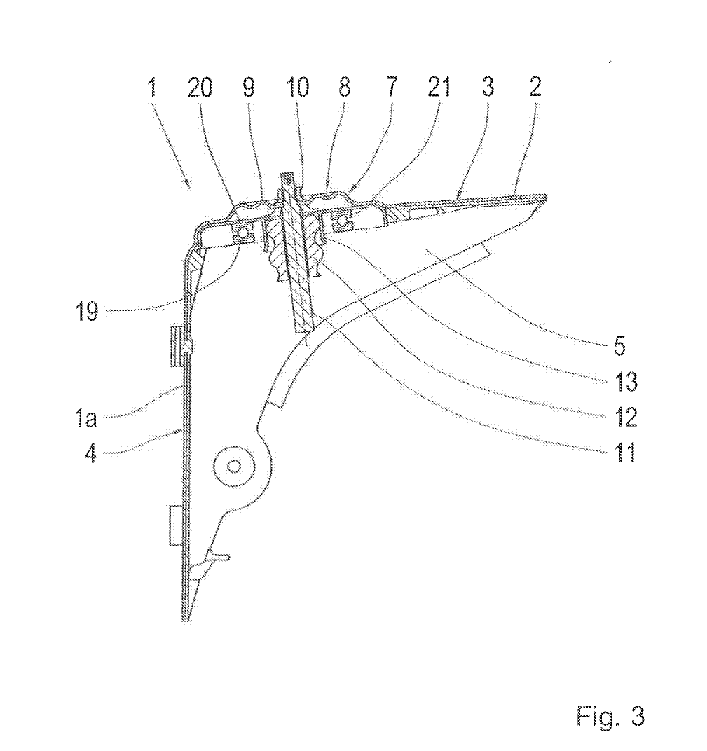

### DETAILED DESCRIPTION OF THE PREFERRED EMBODIMENTS

A suspension strut holder 1 according to an embodiment of the present invention comprises an outer wall 2, which has a first section 3 extending transversely to the spring deflection of a suspension strut and a second section 4 that extends almost perpendicularly thereto. Between the first and second sections 3, 4 there are lateral sections 5, which increases the rigidity of the suspension strut holder 1. The first and second sections 3, 4 have assembly aids 6 by means of which the suspension strut holder 1 can be fixed onto transverse or longitudinal support members (not shown) of a body of a motor vehicle.

Into the first section 3 is integrated a suspension strut supporting mounting 7, i.e. the outer wall 2 of the suspension strut holder 1 and the suspension strut supporting mounting 7 are made integrally from organic sheet and form an organic sheet component 1a. The suspension strut supporting mounting 7 comprises a wall 9 provided with corrugations 8, the corrugations 8 extending concentrically around a through-hole 10 for a piston rod 11 of the suspension strut. In other words, the wall 9 has an uneven, in particular undulating surface with the corrugations running concentrically around the through-hole 10. When the piston rod 11 moves along the spring deflection direction, this structure supports expansion and contraction of the wall 9. Thus, by virtue of the corrugations 8, the spring properties of the suspension strut supporting mounting 7 can be influenced or adjusted.

Furthermore, the suspension strut holder 1 comprises a compression buffer 12 in a stop pot 13. The compression buffer 12 serves as an end stop for the spring deflection and is designed to be compressed in the stop pot 13.

On the inside of the suspension strut holder 1 is arranged a plastic injection-molded component 14. The injection-molded component 14 covers the whole inner side of the outer wall 2. In the area of the suspension strut supporting mounting the injection-molded component 14 has a plurality of reinforcing ribs 15 perpendicular to one another. The injection molded component 14 also comprises connecting or assembly components such as cable guides 16, and in addition ridge-like webs 17 that extend parallel to the lateral sections 5. Between the lateral sections 5 and the webs 17 are arranged metallic inserts 18 with additional assembly aids.

In addition the suspension strut holder 1 comprises a thrust bearing 19 for a spring (not shown) of the suspension strut. The thrust bearing 19 consists of plastic and is arranged on the inside of the section 3 in a cover-like pressure distributor 20 made of metal. The pressure distributor can be screwed to the outer wall 2 in the area of the first section. In the thrust bearing 19 is arranged a ball bearing 21, which in a McPherson front axle serves to enable steering movements relative to a fixed body connection.

### INDEXES

1 Suspension strut holder, holder
1a Organic sheet component
2 Outer wall
3 First section
4 Second section
5 Lateral section
6 Assembly aids
7 Suspension strut supporting mounting
8 Corrugations
9 Wall
10 Through-hole
11 Piston rod
12 Compression buffer
13 Stop pot
14 Injection-molded connect
15 Reinforcing ribs
16 Cable guides
17 Ridge-like webs
18 Metal inserts
19 Thrust bearing
20 Pressure distributor
21 Ball bearing

1-10. (canceled)

11. A holder (1) for a shock-absorber element of a motor vehicle, the holder comprising:
a supporting mounting (7) for the shock-absorber element,
the holder (1) and the supporting mounting (7) being made integrally as an organic sheet component (1a).

12. The holder (1) according to claim 11, wherein an area of the organic sheet component (1a), that forms the supporting mounting (7), is made elastically resilient in a direction of a spring deflection of the shock-absorber element held in the holder (1).

13. The holder (1) according to claim 11, wherein an area of the organic sheet component (1a) forming the supporting mounting (7) has an uneven surface.

14. The holder (1) according to claim 13, wherein the area of the organic sheet component (1a), forming the supporting mounting (7), is either circular or annular and has an undulating surface, with undulations running concentrically around a mid-point of the area of the organic sheet component of the holder (1) that forms the supporting mounting (7).

15. The holder (1) according to claim 13, wherein the area of the organic sheet component (1a), forming the supporting mounting (7), is either circular or annular and has at least one corrugation (8), which runs concentrically around a mid-point of the area of the organic sheet component of the holder (1) that forms the supporting mounting (7).

16. The holder (1) according to claim 11, wherein a rigidity of an area of the organic sheet component (1a), forming the supporting mounting (7), is lower than a rigidity of at least one other area of the organic sheet component (1a).

17. The holder (1) according to claim 11, wherein the organic sheet component (1a) has two different reinforcing fibers such that an area of the organic sheet component (1a), forming the supporting mounting (7), contains fibers which are less rigid than reinforcing fibers present in at least one other area of the organic sheet component (1a).

18. The holder (1) according to claim 17, wherein the more rigid reinforcing fibers are in a form of at least one of carbon fibers and graphite fibers.

19. The holder (1) according to claim 11, wherein a plastic inner component is injected onto an inner side of the holder (1) such that the plastic inner component coats the inner side of the holder (1).

28. The holder (1) according to claim 19, wherein the plastic inner component comprises at least one of:
at least one reinforcing rib (15); or
at least one cable guide (16).

21. A holder for a motor vehicle suspension strut which moves in a spring deflection direction, the holder comprising:
an outer wall having a first wall section and a second wall section,
the first wall section having a supporting mount which supports an end of the suspension strut such that the spring deflection direction is substantially perpendicular to the first wall section,
the supporting mount having concentric undulations which alter a spring function of the holder, and
the supporting mount and at least the first wall section of the outer wall being integrally formed from an organic sheet component.
